(19) United States
(12) Patent Application Publication
(10) Pub. No.: US 2007/0287524 A1
(43) Pub. Date: Dec. 13, 2007

(54) GAMING APPARATUS

(75) Inventor: Kazunobu SATO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/750,592

(22) Filed: May 18, 2007

(30) Foreign Application Priority Data
May 29, 2006 (JP) 2006-148939

(51) Int. Cl. A63F 13/00

(52) U.S. Cl. 463/20

(57) ABSTRACT

An object of the invention is to provide a gaming apparatus in which contents of a game are intriguing and highly varied.

A gaming apparatus of the invention including a plurality of variable display portions which each display one symbol, a variation of symbols in the variable display portions is started on a condition that a medal has been inserted in a medal insertion slot, the symbols stop after a prescribed time, and a prescribed amount of medals is paid out based on a stopped symbol combination. A symbol array being variably displayed in each variable display portion in such a way as to be scrolled, as symbol arrangements, a first symbol arrangement pattern, and a second symbol arrangement pattern which becomes a game condition differing from a game condition according to the first symbol arrangement pattern, are included. Then, in the event that a prescribed condition, for example, a game quantity reaching a prescribed value, is fulfilled, the second symbol arrangement pattern is selected, and a symbol variation, and an award based thereon, that is, a medal payout process, are executed.

### RELATED APPLICATION

This application claims the priority of Japanese Patent Application No. 2006-148939 filed on May 29, 2006, which is incorporated herein by reference.

### BACKGROUND OF THE INVENTION

1. Technical Field

The present invention relates to a gaming apparatus, such as a slot machine, in which symbols aligned in a plurality of arrays are variably displayed.

2. Related Art

To date, a gaming machine (for example, a slot machine or the like) which, by causing a revolving reel (a variable display device), on a perimeter of which a symbol array is provided, to revolve, carries out a game variably displaying symbols has been known. Commonly, as the variable display device installed in this kind of gaming machine, one which varies the symbols by mechanically revolving an actual revolving reel, or one which variably displays the symbols by simulating a revolution of the revolving reel on an image display device such as a liquid crystal display device or a CRT, have been known.

This type of gaming machine, in general, by inserting a medal or a coin (hereafter called a game medium) and carrying out a prescribed start operation (a depression operation of a spin button or the like), varies a plurality of the variable display devices whereon, based on a selection result of an internal selection, a stop process of a plurality of varying symbols is carried out. Then, based on a combination of stopped symbols, a prescribed amount of tokens is granted to a player.

Also, for example, as disclosed in Japanese Unexamined Patent Publication No. 2001-87452, a gaming machine has been known which, in the event that a stopped aspect of the symbols is in a prescribed condition, grants a special game (for example, a bonus game such as a free game) which is advantageous to the player. According to this kind of gaming machine, as it may happen, while playing the regular game, that a transfer is made to the special game in which a large quantity of tokens can be obtained, with no danger of a game condition becoming monotonous, it is possible to provide the player with a feeling of excitement and a sense of expectation. Alternatively, as disclosed in Japanese Unexamined Patent Publication No. 2004-351052, a gaming machine has also been known in which the tokens are regularly pooled and, when a prescribed condition is fulfilled, a transfer is made to a so-called progressive bonus game, which grants the tokens.

The regular game and the special game in the heretofore described gaming machine being determined by a prescribed internal selection process (a selection process based on a selection table) carried out every time a game starts, by the special game being established, it is possible for the player to obtain more tokens. For this reason, a probability of the special game being established by the internal selection process is set low, by which means a stimulus is given to the player playing the game, and he or she is prevented from becoming bored with the game.

However, in this kind of gaming machine, as well as a selection of symbols to be displayed in the variable display device being carried out based on the same symbol arrangement pattern and selection table every time, operations such as a varying and a stopping of symbols are repeated, meaning that the game becomes monotonous, and there is a problem of a lack of variety.

Also, the heretofore known kinds of gaming machine include various winning combinations such as a big bonus, called the progressive bonus, which grants a relatively big privilege to the player, and a small bonus which grants a relatively small profit to the player, but the player hopes to win the big bonus rather than this kind of small bonus. That is, in a case of winning only small bonuses without winning the big bonus, as well as reducing the player's interest in the game, as the player cannot restart the game while the tokens are being paid out when winning the small bonus, he or she feels annoyed. It is not easy to simply raise a probability of obtaining the big bonus because of a relationship with a payout rate.

### SUMMARY OF THE INVENTION

The invention, being contrived focusing on the heretofore described problems, has an object of providing a gaming machine in which game contents are intriguing and highly varied.

1. In order to achieve the heretofore described object, the invention is a gaming apparatus including: a display which, including a plurality of variable display portions each displaying one symbol, displays a plurality of symbols; a memory which stores a first symbol arrangement pattern which fixes symbol arrangements to be displayed in the variable display portions, and a second symbol arrangement pattern which becomes a game condition differing from a game condition according to the first symbol arrangement pattern; and a controller which controls the display and the memory. The controller, (a) based on a prescribed condition, selects either the first symbol arrangement pattern or the second symbol arrangement pattern, and carries out a varying display of the symbols on the display, (b) determines symbols to be displayed in the variable display portions based on the selected symbol arrangement pattern, and (c) in the event that a combination of the determined symbols is one of a pre-determined plurality of winning combinations, carries out an award.

2. In the gaming apparatus according to 1 of the invention, kinds of symbol included in the second symbol arrangement pattern are fewer than kinds of symbol included in the first symbol arrangement pattern.

3. In the gaming apparatus according to 2 of the invention, the first symbol arrangement pattern and the second symbol arrangement pattern include specified symbols configuring a winning combination which grants a privilege relatively advantageous to the player. By making a quantity of the specified symbols included in the second symbol arrangement pattern greater than that of the specified symbols included in the first symbol arrangement pattern, an acquisition probability of the relevant specified symbols is increased.

4. In the gaming apparatus according to 3 of the invention, the second symbol arrangement pattern is configured with the specified symbols and blank symbols which configure no plurality of winning combinations at all.

5. In the gaming apparatus according to 1 of the invention, the prescribed condition is a number of times the game is played.

According to the gaming apparatus of the invention, as it includes differing symbol arrangement patterns, it is possible to produce a highly intriguing, diverse gaming aspect.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

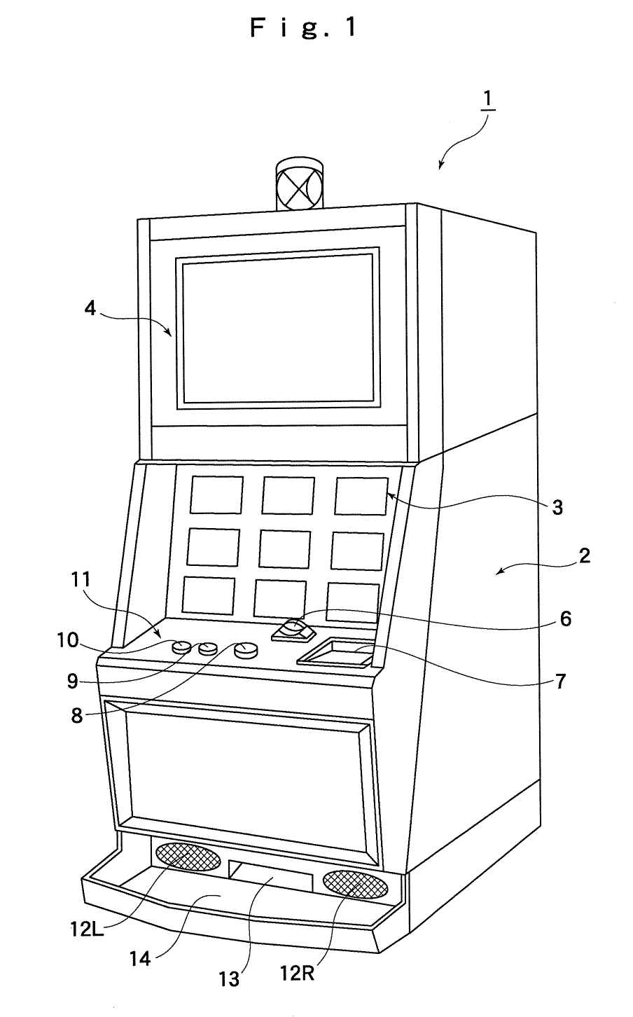

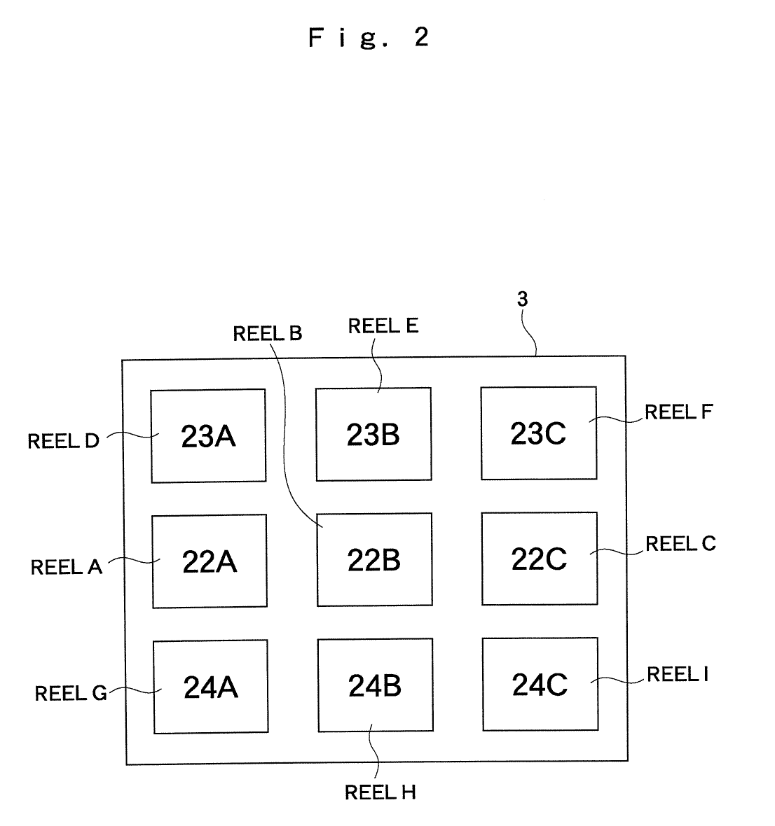

FIG. 1 is a view showing an embodiment of a gaming machine containing a gaming apparatus according to the invention, which is an external perspective view showing a slot machine.

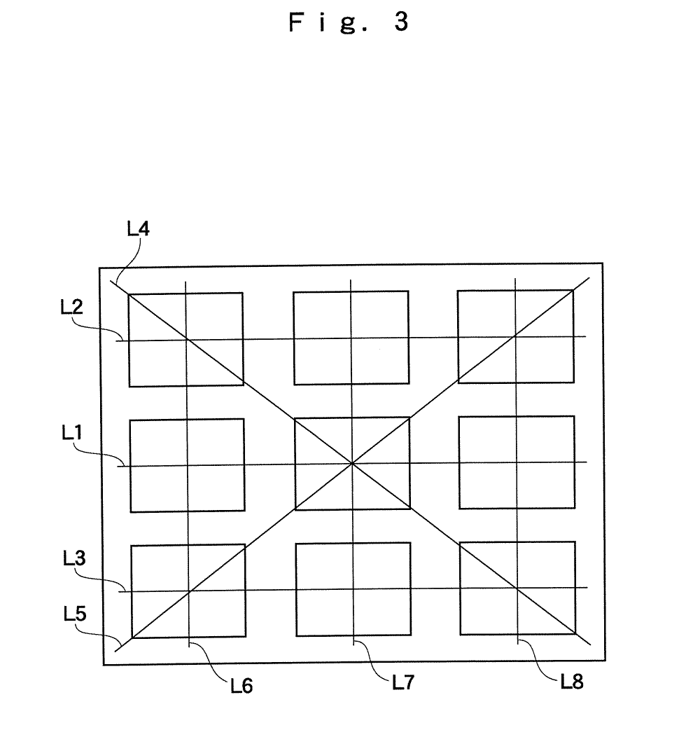

FIG. 2 is a view showing a configuration of variable display portions of a main display.

FIG. 3 is a view showing positions of activated pay lines.

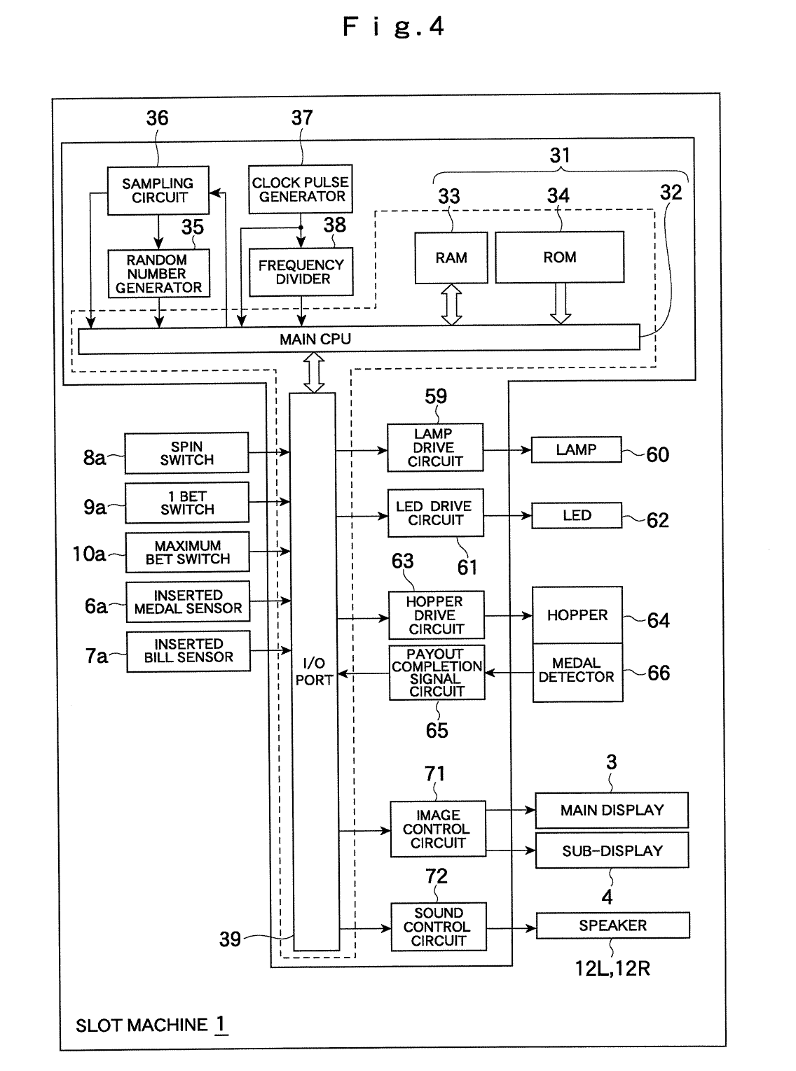

FIG. 4 is a block diagram schematically showing a control system of the slot machine.

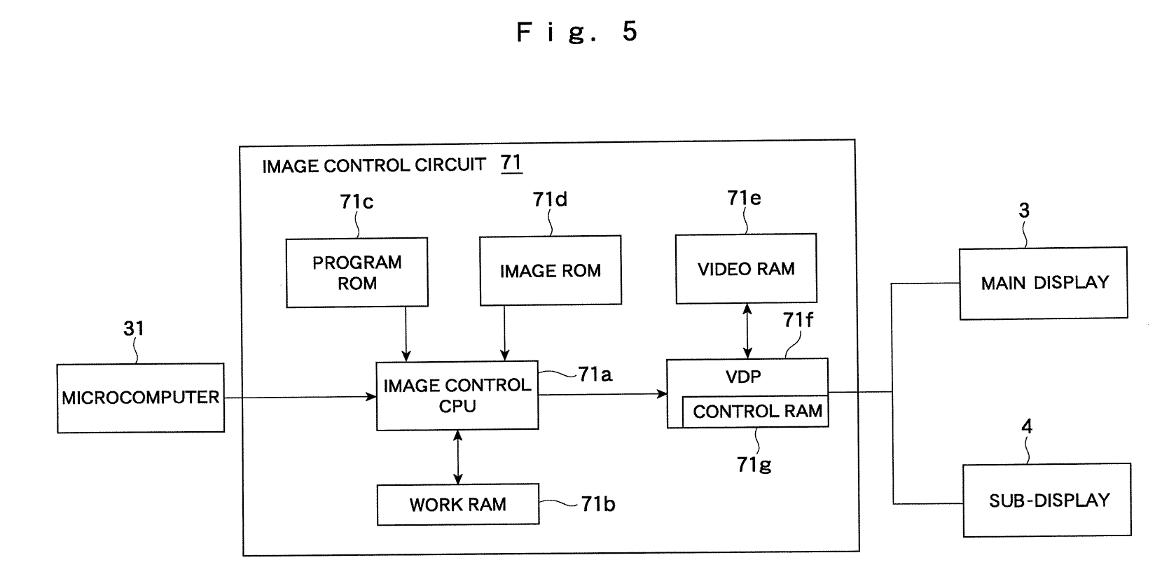

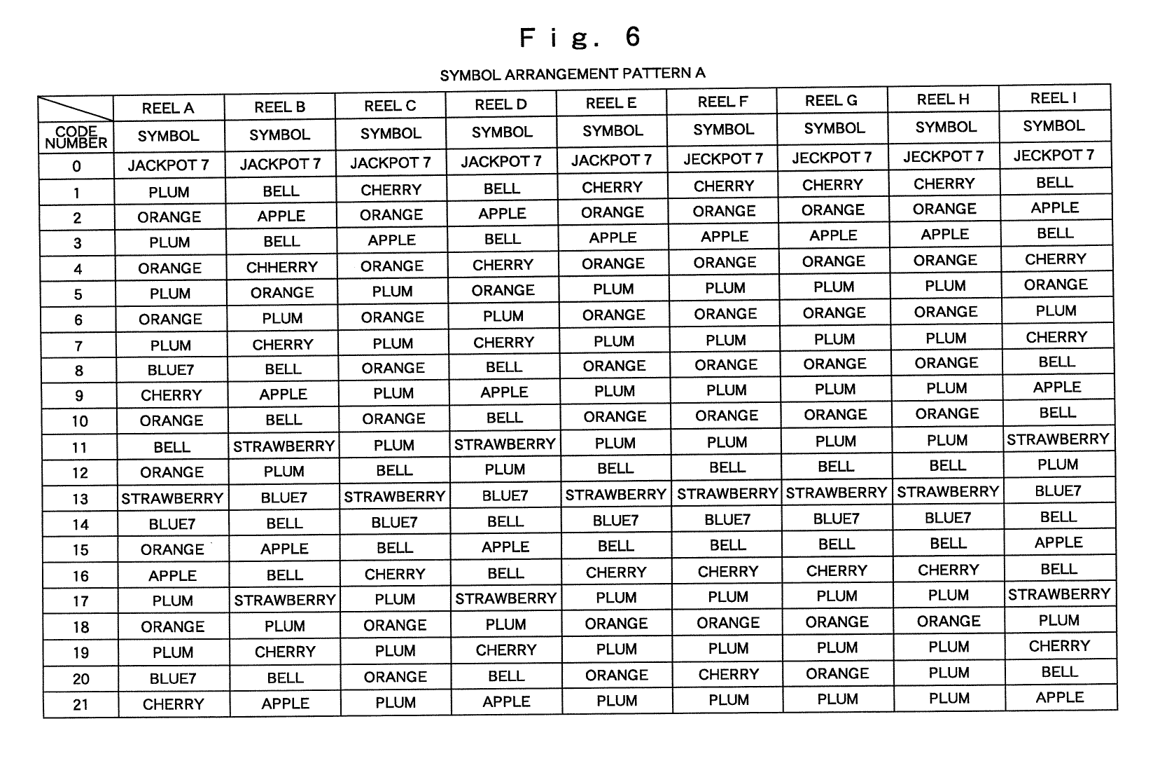

FIG. 5 is a block diagram showing an example of an internal configuration of an image control circuit.

FIG. 6 is a diagram showing a symbol arrangement pattern table.

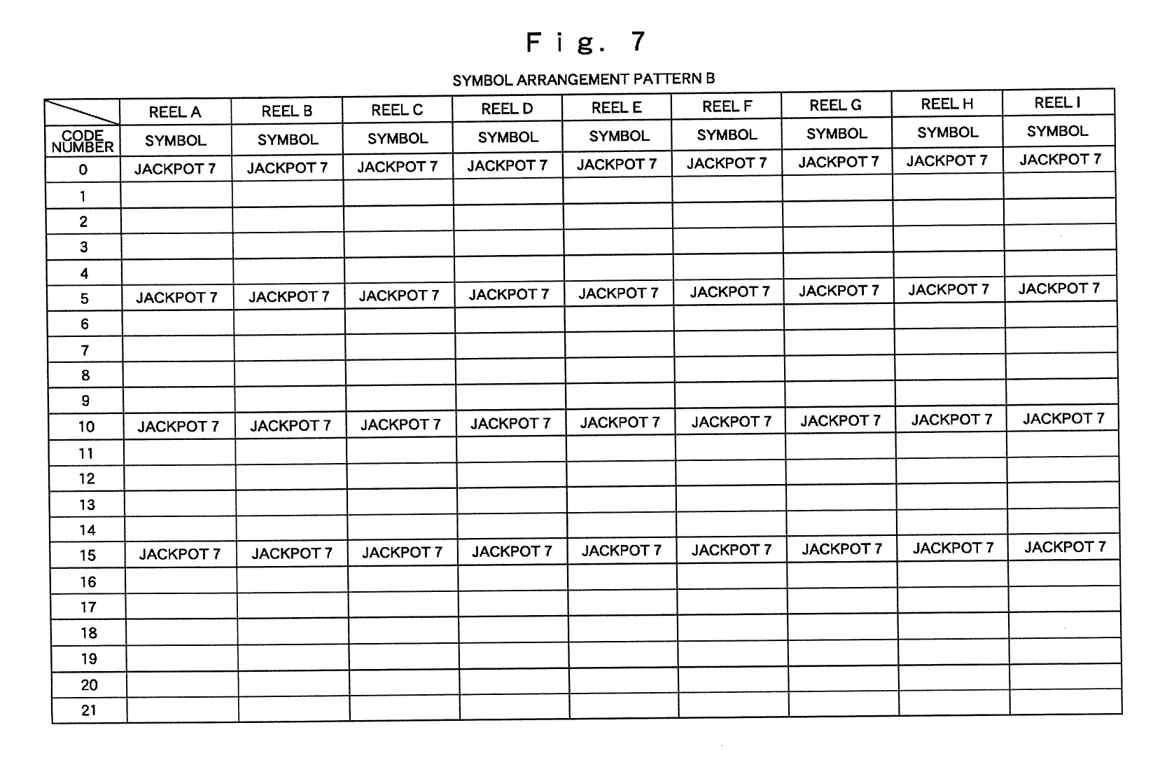

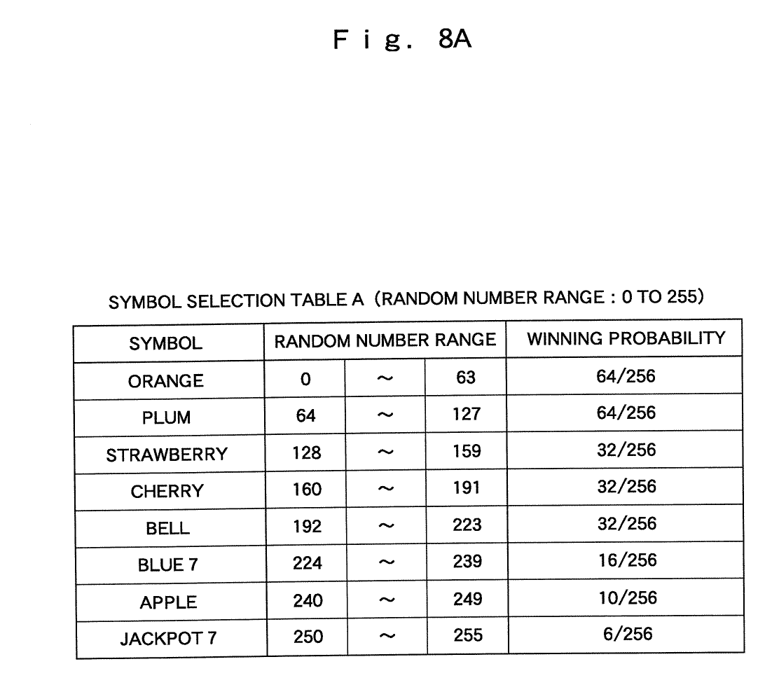

FIG. 7 is a diagram showing a symbol arrangement pattern table selected when a prescribed condition is fulfilled.

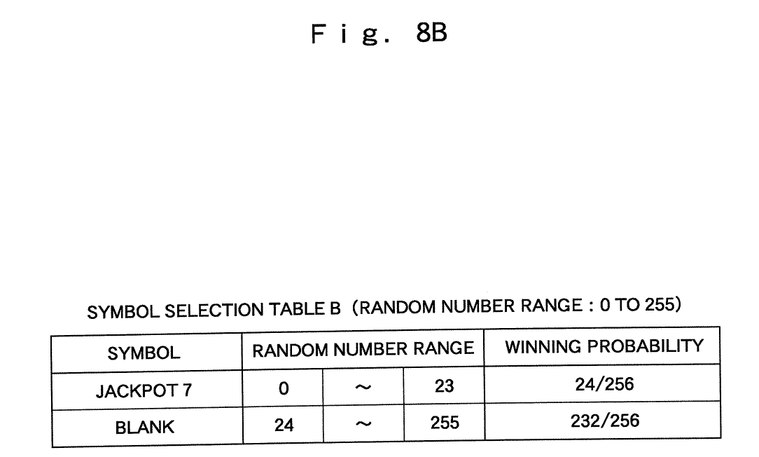

FIG. 8A is a diagram showing a symbol selection table used in a symbol selection process when the symbol arrangement pattern shown in FIG. 6 is selected, while FIG. 8B is a diagram showing a symbol selection table used in a symbol selection process when the symbol arrangement pattern shown in FIG. 7 is selected.

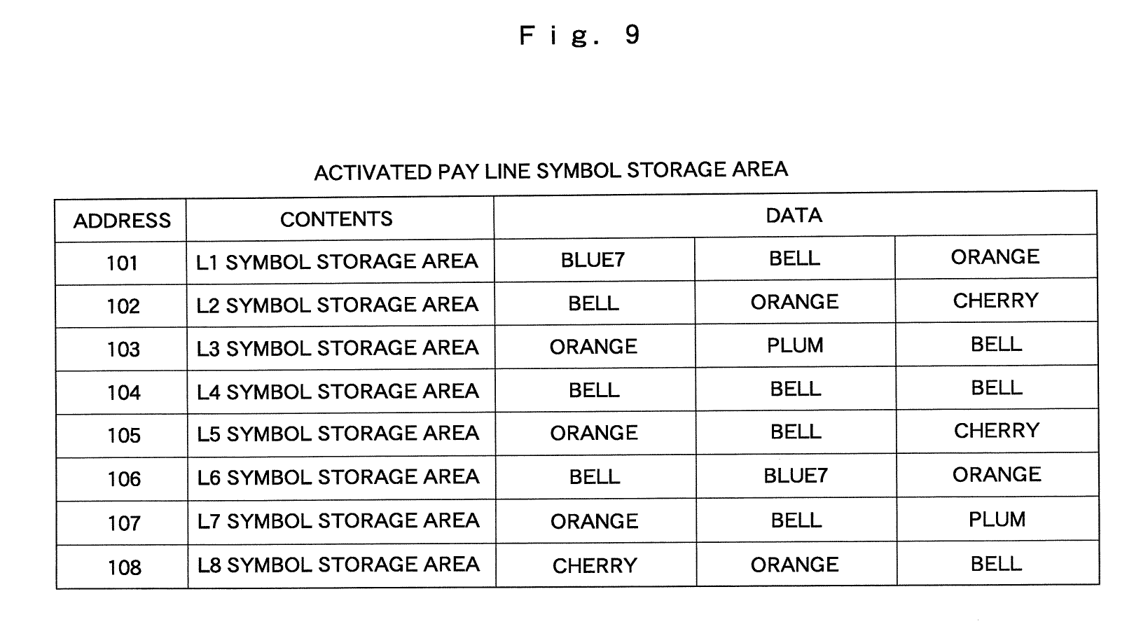

FIG. 9 is a diagram showing an example of data stored in an activated pay line symbol storage area.

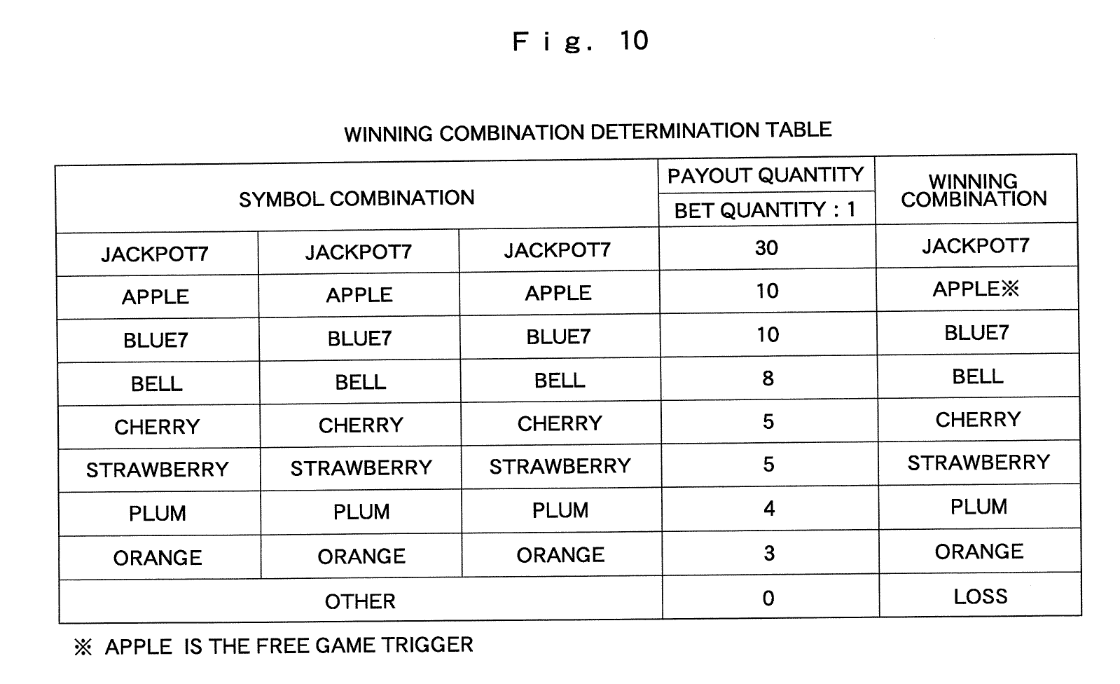

FIG. 10 is a diagram showing a winning combination determination table.

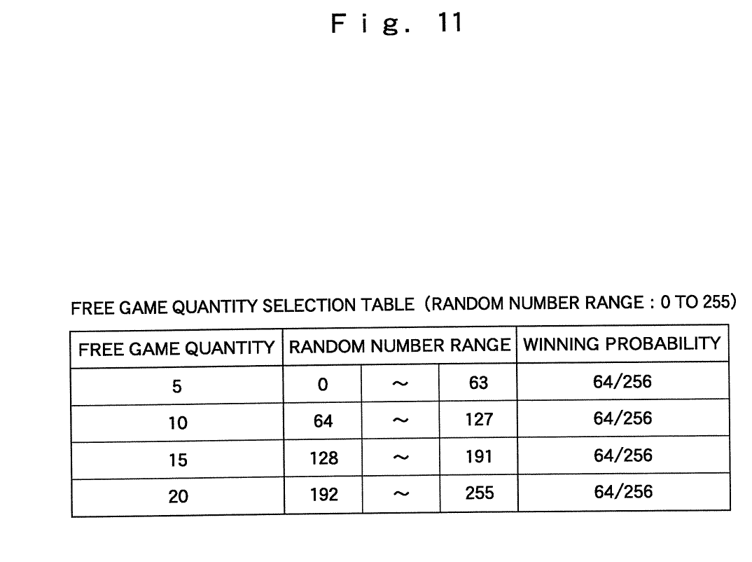

FIG. 11 is a diagram showing a free game quantity selection table.

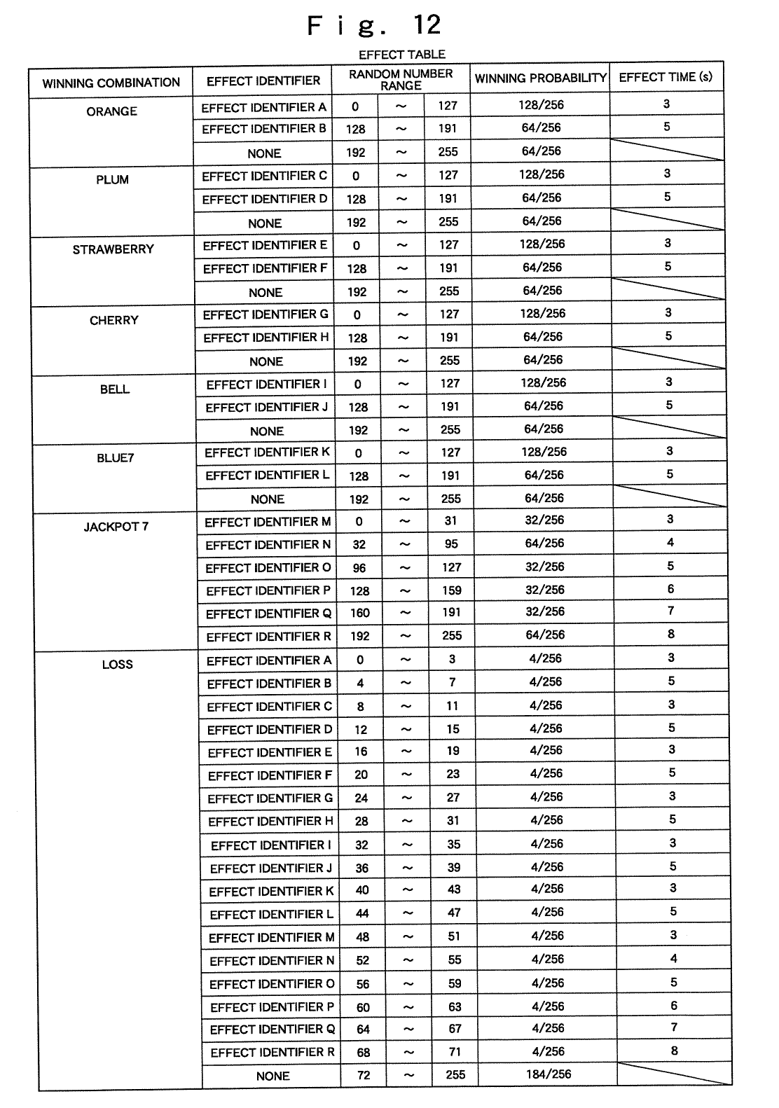

FIG. 12 is a diagram showing an effect table.

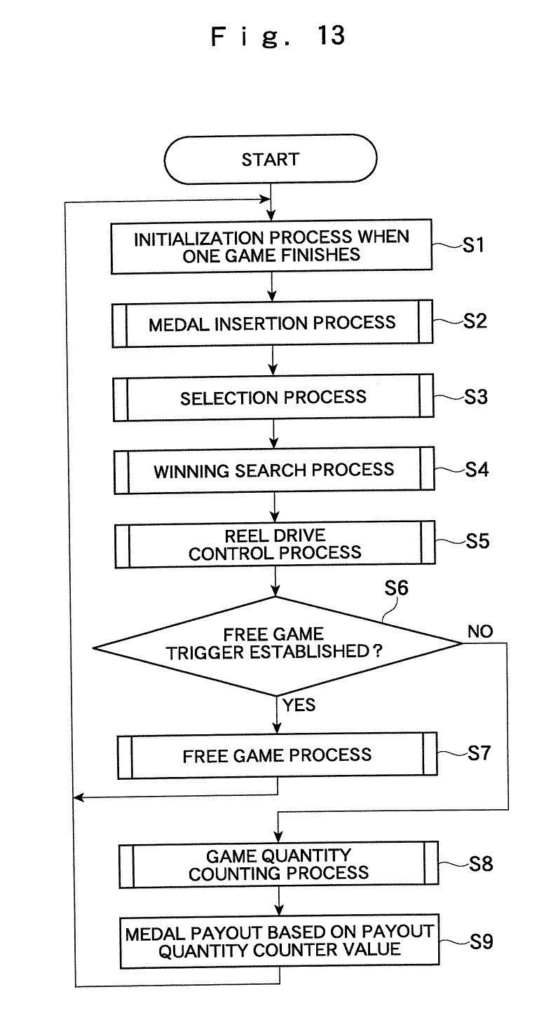

FIG. 13 is a main flowchart showing an example of an implementation procedure of a game in the slot machine.

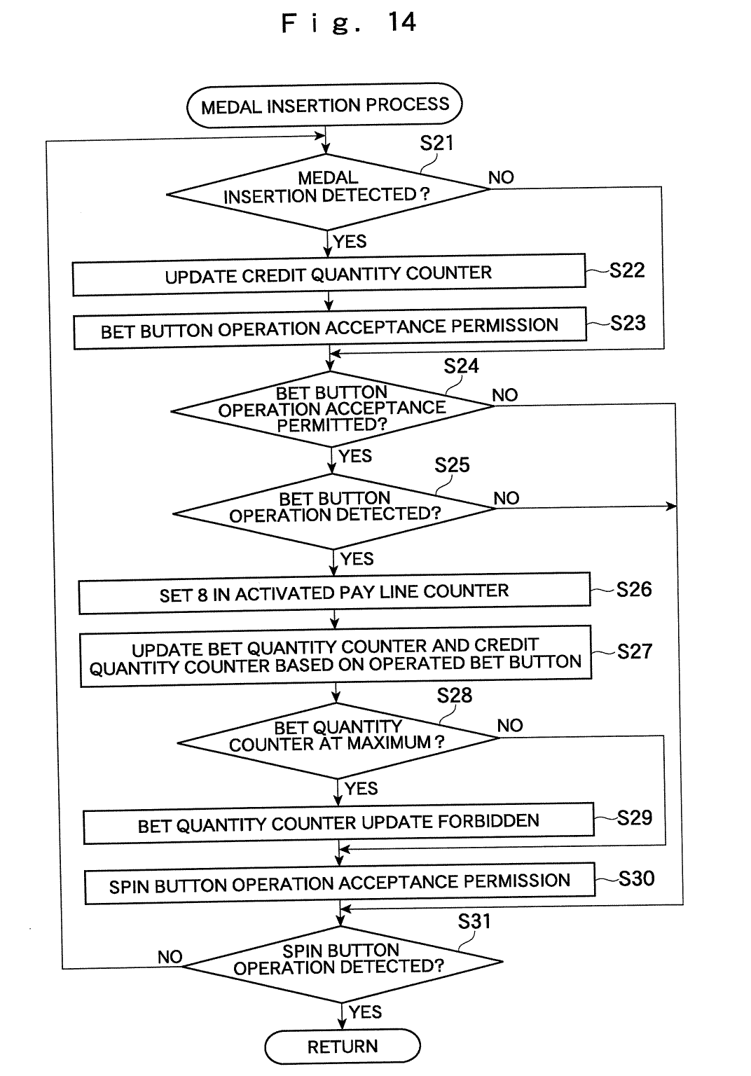

FIG. 14 is a flowchart showing an example of a medal insertion process procedure in the flowchart shown in FIG. 13.

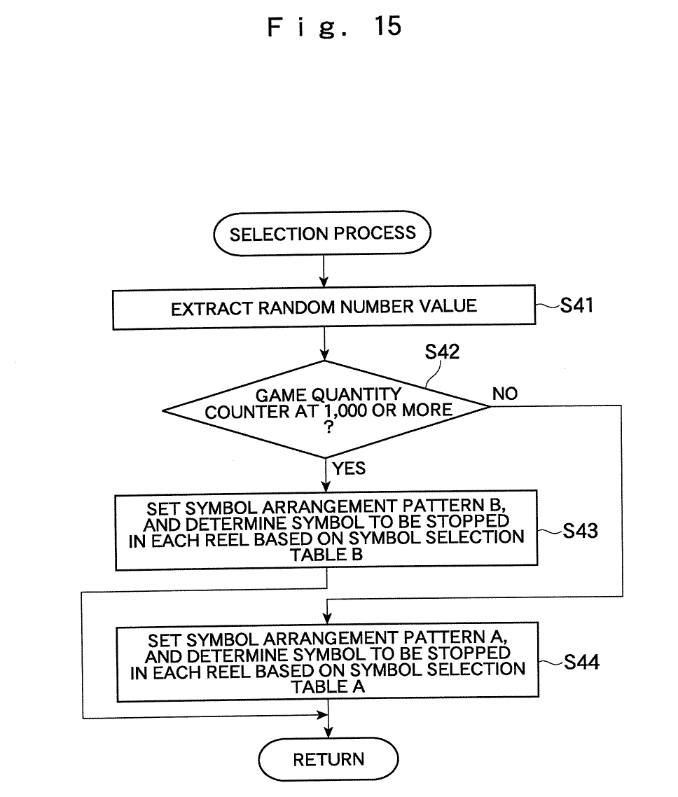

FIG. 15 is a flowchart showing an example of a selection process procedure in the flowchart shown in FIG. 13.

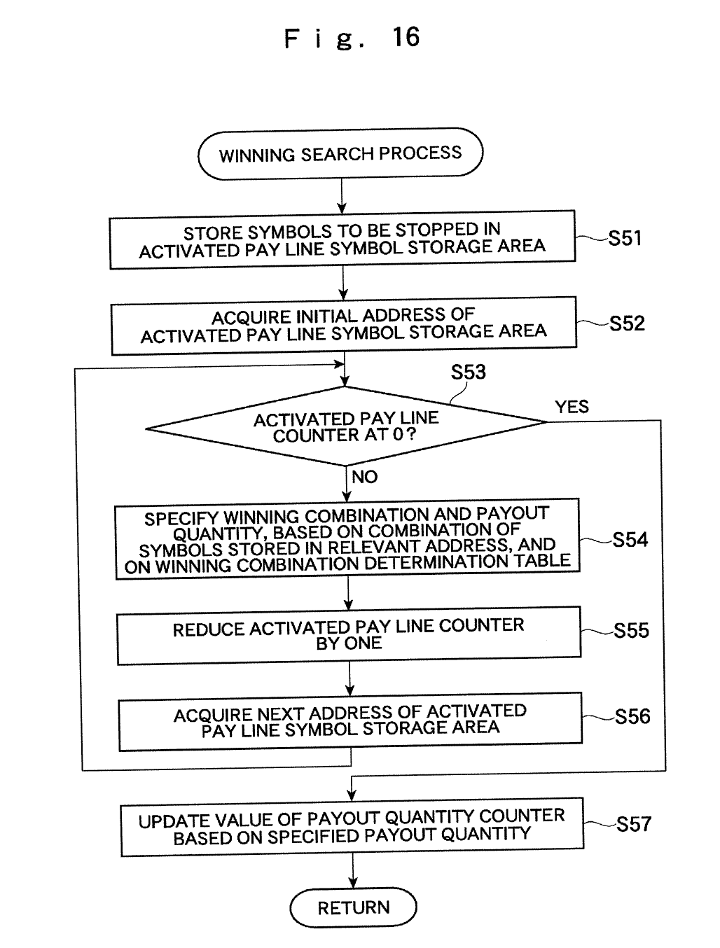

FIG. 16 is a flowchart showing an example of a winning search process procedure in the flowchart shown in FIG. 13.

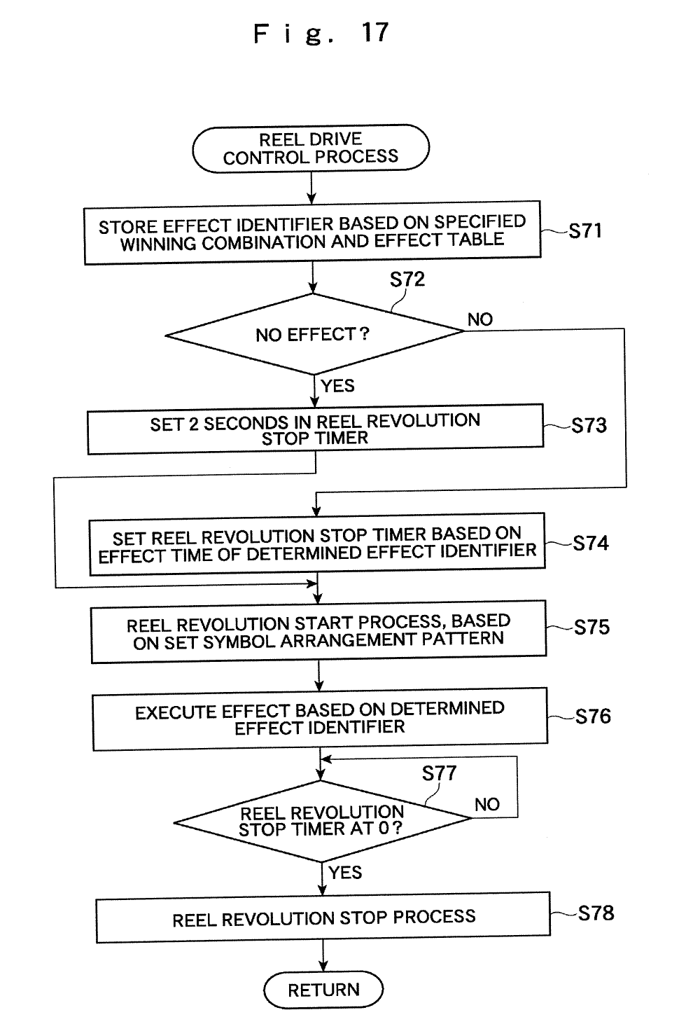

FIG. 17 is a flowchart showing an example of a reel drive control process procedure in the flowchart shown in FIG. 12.

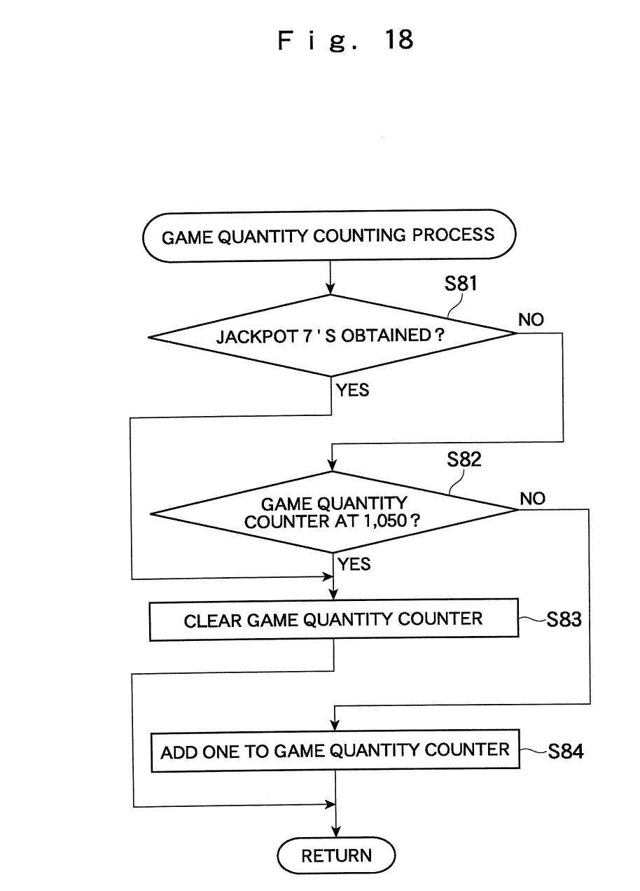

FIG. 18 is a flowchart showing an example of a game quantity counting process procedure in the flowchart shown in FIG. 13.

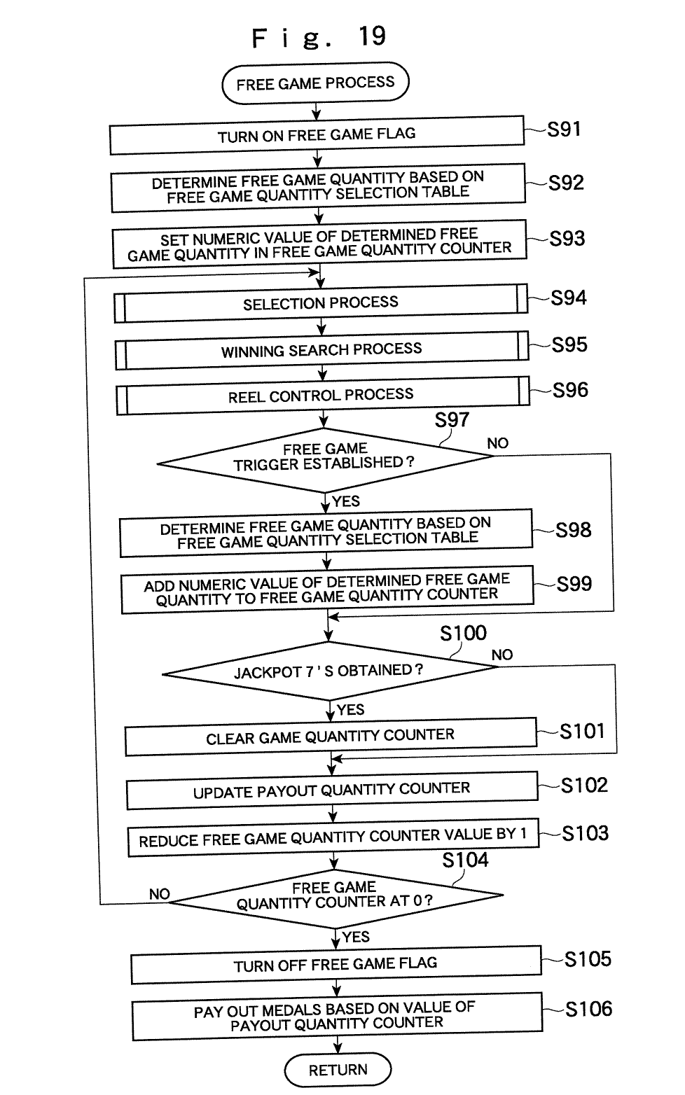

FIG. 19 is a flowchart showing an example of a free game process procedure in the flowchart shown in FIG. 13.

### DESCRIPTION OF THE PREFERRED EMBODIMENTS

A gaming apparatus according to the embodiment includes: a display which, including a plurality of variable display portions each displaying one symbol, displays a plurality of symbols; a memory which stores a first symbol arrangement pattern which fixes symbol arrangements to be displayed in the variable display portions, and a second symbol arrangement pattern which becomes a game condition differing from a game condition according to the first symbol arrangement pattern; and a controller which controls the display and the memory. The controller, (a) based on a prescribed condition, selects either the first symbol arrangement pattern or the second symbol arrangement pattern, and carries out a varying display of the symbols on the display, (b) determines symbols to be displayed in the variable display portions based on the selected symbol arrangement pattern, and (c) in the event that a combination of the determined symbols is one of a pre-determined plurality of winning combinations, carries out an award.

With the gaming apparatus of the heretofore described configuration, including the plurality of variable display portions, the winning combination is established when the combination of the symbols displayed in the variable display portions becomes a prescribed condition, and the award is carried out for a player. Although the symbols displayed in the variable display portions are determined by means of a prescribed selection process based on the symbol arrangement patterns stored in the memory, two symbol arrangement patterns are stored in the memory. Although, normally, the symbol display in the variable display portions is carried out based on one of the symbol arrangement patterns (the first symbol arrangement pattern), of the two symbol arrangement patterns, the other symbol arrangement pattern (the second symbol arrangement pattern) being selected when the prescribed condition is fulfilled, by this kind of second symbol arrangement pattern being selected, a transfer is made to the game condition differing from the game according to the first symbol arrangement pattern.

That is, as the symbols (the varying symbols or the arrangement pattern thereof) displayed in the variable display portions transfer to the condition differing from the game thus far by the fulfillment of the prescribed condition, it is possible to make an impact on the player, and a highly intriguing, diverse gaming aspect is produced. Also, by having that kind of game condition as a target, a contribution is also made to a continuity of the game.

Also, kinds of symbol included in the second symbol arrangement pattern are made fewer than kinds of symbol included in the first symbol arrangement pattern.

With this kind of configuration, by the prescribed condition being fulfilled and the second symbol arrangement pattern being selected, the kinds of winning combination based on the combinations of the symbols decrease, meaning that, as well as a win and a loss being clarified, each winning combination becomes easier to acquire in the selected second symbol arrangement pattern, and it is possible to heighten the player's sense of expectation.

Also, the first symbol arrangement pattern and the second symbol arrangement pattern including specified symbols configuring a winning combination which grants a privilege relatively advantageous to the player. By making a quantity of the specified symbols included in the second symbol arrangement pattern greater than that of the specified symbols included in the first symbol arrangement pattern, it is possible to increase an acquisition probability of the relevant specified symbols.

With this kind of gaming apparatus, as the specified winning combination becomes easier to acquire than in the game condition according to the first symbol arrangement pattern by the prescribed condition being fulfilled and the second symbol arrangement pattern being selected, it is possible to heighten the player's sense of expectation.

Also, the second symbol arrangement pattern can be configured with the specified symbols and blank symbols which configure no plurality of winning combinations at all.

With this kind of configuration, by the prescribed condition being fulfilled and the second symbol arrangement pattern being selected, there are only two conditions, the acquisition or a non-acquisition of the specified winning combination, meaning that, as well as the win and the loss being further clarified, as the specified winning combination is automatically acquired in the event of the win, it is possible to further heighten the player's sense of expectation.

Furthermore, it is possible to have a number of times the game is played as the prescribed condition.

With this kind of gaming apparatus, as the second symbol arrangement pattern is unfailingly selected by games being played consecutively, as well as it being possible to unfailingly provide the player with the differing game condition, as there is an increased tendency for the player not to leave a gaming machine containing the gaming apparatus until the number of times is reached, it is possible to increase an operating rate of the gaming machine.

Hereafter, a detailed description of a gaming apparatus according to the invention will be given, while referring to the drawings, based on an embodiment of the invention realized as a slot machine, which is an example of a gaming machine.

FIG. 1 is a perspective view showing an overall configuration of a slot machine, which is an example of a gaming machine. A slot machine 1, having a cabinet 2, has a main display 3 equipped with a liquid crystal display device on a front surface of the cabinet 2. Also, it has a sub-display 4, likewise equipped with a liquid crystal display device, in a portion above the main display 3.

The main display 3, including a plurality of variable display portions which simulate a display of revolving reels, as will be described hereafter, and, as shown in FIG. 2, having the plurality of variable display portions (in the embodiment, a total of nine variable display portions 22A, 22B, 22C, 23A, 23B, 23C, 24A, 24B and 24C, disposed in three each of vertical and horizontal arrays) in a screen thereof, is configured in such a way that the plurality of variable display portions are visually perceived by a player as one block.

It is also acceptable that the main display 3, being configured as a display device having a transmissive touch sensitive panel, is configured in such a way as to receive various kinds of input command by the player touching the touch sensitive panel.

A regular game, and a special game (also called a free game) granting a game medium, relatively advantageous to the player in comparison with the regular game, are executed, by means of a game control device to be described hereafter, on the main display 3. In this case, in both the regular game and the special game, scroll display images (reel images reel A to reel I displayed exactly as though mechanical reels were revolving), in which it appears that a plurality of symbols are moving from a top to a bottom, being displayed in the variable display portions 22A to 22C, 23A to 23C and 24A to 24C, a grant amount of the game medium is fixed in advance in accordance with a stopped symbol arrangement in the variable display portions.

In the embodiment, the nine variable display portions 22A to 22C, 23A to 23C and 24A to 24C being arranged as heretofore described, regarding lines for determining a symbol arrangement, a total of eight lines (L1 to L8), composed of the three each of the vertical and horizontal arrays and arrangements on diagonal lines, are all set in one game (refer to FIG. 3).

Also, it is also acceptable that the main display 3 includes an effect display area in which an image for dramatizing the game is displayed. For example, it is acceptable to dispose the effect display area in a peripheral area of the heretofore described variable display portions, and to display therein various kinds of effect image, background image and the like which have no relationship with the variable displays simulating the revolving reels in the variable display portions 22A to 22C, 23A to 23C and 24A to 24C. Naturally, it is also acceptable that an image display portion for displaying the effect image is of a configuration in which an image display device such as a liquid crystal display portion is installed, separately, apart from the main display 3 and the sub-display 4.

For example, a gaming method, a payout table indicating kinds of winning combination and their awards, various kinds of effect and the like related to the game, information related to the game and the like are displayed on the sub-display 4 provided above the main display 3. Naturally, it is also acceptable that this portion is simply one incorporating a panel on which game details are depicted, rather than an image display device such as the liquid crystal display device.

An approximately horizontal pedestal portion 11 is provided below the main display 3. A medal insertion slot 6, a bill accepter 7, a spin button 8, a 1 BET button 9 and a maximum BET button 10 are provided on the pedestal portion 11.

The medal insertion slot 6, being provided for the player to insert a token such as a coin or a medal (hereafter called a medal), for betting on the game, has an inserted medal sensor which transmits a signal indicating an insertion of the medal. Also, the bill accepter 7, being provided for the player to insert a bill, which is one kind of token, has an inserted bill sensor which transmits a signal indicating an insertion of the bill.

Apart from the heretofore described coin, medal and bill, a recording medium or the like which records information regarding the token, such as a pre-paid card, is also included in the token.

The spin button 8 including a function as a start signal transmission device which instructs a start of a unit game based on a start operation of the player, by means of an operation of the spin button, a spin switch provided internally emits a detection signal, as a result of which the scroll display images of the symbols are displayed in the variable display portions 22A to 22C, 23A to 23C and 24A to 24C.

The 1 BET button 9 is provided for carrying out a setting of betting one medal by means of one operation, while the maximum BET button 10 is provided for carrying out a setting of betting a maximum quantity of medals which can be bet on one game by means of one operation. The operation of these buttons being detected by an internally provided 1 BET switch and maximum BET switch, a detection signal is emitted.

Also, in the slot machine 1, a medal payout opening 13 and a medal receiving tray 14, which collects paid out medals, are provided at a bottom of the cabinet 2. Furthermore, speakers 12L and 12R are provided, sandwiching the medal payout opening 13, on a left side and a right side respectively.

Next, a description will be given, with reference to FIG. 4, of the game control device which controls a game operation of the slot machine 1. FIG. 4 being a block diagram schematically showing the game control device which controls the game operation of the slot machine, the game control device includes a plurality of components centered around a microcomputer 31.

The microcomputer 31 has a main CPU (Central Processing Unit) 32, which is also a controller of the invention, an RAM (Random Access Memory) 33 and an ROM (Read Only Memory) 34.

Various kinds of program for carrying out processes necessary for an implementation of the game, such as a main process, a medal insertion process, a reel drive control process, a selection process, a winning search process and a free game process, all to be described hereafter, and, during the implementation of the game, various data tables such as a symbol arrangement pattern A or B of the revolving reels displayed in the variable display portions 22A to 22C, 23A to 23C and 24A to 24C (refer to FIGS. 6 and 7), and a selection table for selecting a stopped display symbol of the game (refer to FIGS. 8A and 8B), are stored in the ROM 34. That is, the ROM 34 stores the symbol arrangement patterns shown in FIGS. 6 and 7.

Also, the RAM 33 being a memory including a function as a storage device which temporarily stores various kinds of data on which a calculation process has been carried out in the main CPU 32, when the main CPU 32 operates in accordance with an operation program of the ROM 34, data and programs used are stored in the RAM 33. Furthermore, the RAM 33 includes a counter function, for example, a counter function which counts a quantity of tokens (medals) paid out, a quantity of bets, a quantity of games and the like. In the embodiment, based on a count value of the quantity of games, as will be described hereafter, the main CPU 32 selects a symbol arrangement pattern of the revolving reels and the selection table stored in the ROM 34, and carries out a drive reel drive control relating to a drive signal and a stop signal of each revolving reel, and a control relating to a grant of the token (medal).

The programs, data and the like used when controlling the heretofore described slot machine 1 not being limited to a case in which they are stored in advance in the ROM 34 or RAM 33, it is possible to change as appropriate, such as by storing in a memory device provided on a separate substrate. For example, it is also acceptable to have a configuration in which similar programs, data and the like are stored in a storage medium such as a compact flash (registered trademark), and downloaded from this kind of storage medium onto the ROM 34 or the like, and it is also acceptable that an aspect is such that an authentication process or the like is carried out with a host computer, and that kind of program or the like is downloaded.

A clock pulse generator 37, which generates a standard clock pulse, and a frequency divider 38 being connected to the main CPU 32, a random number generator 35 and a sampling circuit 36, which configure a selection processing device, are also connected. The random number generator 35, operating in accordance with an instruction from the main CPU 32, generates random numbers in a certain range. The sampling circuit 36, in accordance with an instruction from the main CPU 32, extracts an optional random number from among the random numbers generated by the random number generator 35, and inputs the extracted random number into the main CPU 32. The clock pulse generator 37 generates the standard clock pulse for operating the main CPU 32, and the frequency divider 38 inputs a signal in which the standard clock pulse is divided by a certain frequency into the main CPU 32. The random number sampled via the sampling circuit 36 is used in various kinds of selection of the winning combination and the like.

Also, the main CPU 32, operating in accordance with the programs stored in the ROM 34, receives a signal, via an I/O port 39, from the medal insertion slot 6 (the inserted medal sensor 6a), the bill accepter 7 (the inserted bill accepter 7a), the spin button 8 (the spin switch 8a), the 1 BET button 9 (the 1 BET switch 9a), or the maximum BET button 10 (the maximum BET switch 10a) provided in the pedestal portion 11 and, based on the signal, carries out an overall operation control accompanying the implementation of the game.

Also, a lamp drive circuit 59, an LED drive circuit 61, a hopper drive circuit 63, and a payout completion signal circuit 65 are connected, via the I/O port 39, to the main CPU 32, and furthermore, an image control circuit 71, which display controls an image to be displayed on the main display 3 and the sub-display 4, and a sound control circuit 72, which carries out a control of a sound emitted from the speakers 12L and 12R, are connected, via the I/O port 39, to the main CPU 32.

The lamp drive circuit 59 carries out the effect of the game by transmitting a signal for illuminating various kinds of lamp 60 to the lamps 60, for example, causing the lamps 60 to flash during an execution of the game. The LED drive circuit 61 controls a flashing display of an LED 62 which carries out a display of information necessary for the implementation of the game such as, for example, a credit quantity display or an acquired quantity display. The lamps 60 and the LED 62, although not shown in FIG. 1, are installed in a portion easily visible to the player.

The hopper drive circuit 63, configuring the medal payout device in conjunction with the hopper 64, drives the hopper 64 in accordance with a control of the main CPU 32, and the hopper 64, carrying out an operation for carrying out a payout of the medal, pays the medal out into the medal payout opening 13 A medal detector 66 counts a quantity of coins paid out by the hopper 64, and notifies the payout completion signal circuit 65 of data of the counted quantity value. The payout completion signal circuit 65 receives the data of the medal quantity value from the medal detector 66 and, in the event that the quantity value reaches data of a set quantity value, transmits a signal informing of a medal payout completion to the main CPU 32.

The image control circuit 71, having a function as a symbol variation device, controls an image display on each of the main display 3 and the sub-display 4, and causes various kinds of image, such as a scrolling symbol image, to be displayed on the main display 3 and the sub-display 4. The image control circuit 71, as shown in FIG. 5, has an image control CPU 71a, a work RAM 71b, a program ROM 71c, an image ROM 71d, a video RAM 71e and a VDP (Video Display Processor) 71f.

The image control CPU 71a, based on parameters set by the microcomputer 31 and in accordance with an image control program stored in advance in the program ROM 71c, determines an image (a symbol image or the like) to be displayed on the main display 3 and the sub-display 4. The work RAM 71b is configured as a temporary storage device for when the image control CPU 71a executes the image control program. The program ROM 71c stores the image control program, the various kinds of selection table and the like. The image ROM 71d stores dot data for forming the image. Data of the various kinds of symbol image are included in the dot data.

Also, the video RAM 71e is configured as a temporary storage device for when the VDP 71f forms the image. In this case, the VDP 71f, having a control RAM 71g, forms images corresponding to display details of the main display 3 and the sub-display 4 determined by the image control CPU 71a, and transmits the images formed to the main display 3 and the sub-display 4.

The sound control circuit 72 transmits a sound signal for emitting the sound from the speakers 12L and 12R to the speakers 12L and 12R. The sound is emitted from the speakers 12L and 12R in order to enliven the game at an appropriate point, for example, after a start of the game.

Next, a description will be given of the symbols used in the game of the slot machine 1.

The reel A to the reel 1, configured of twenty-two symbols (each symbol is allotted a code number from 0 to 21) arrayed in a prescribed order, being cyclically scroll displayed respectively in the variable display portions 22A to 22C, 23A to 23C and 24A to 24C of the main display 3, as shown in the symbol arrangement pattern A of FIG. 6, it appears to the player exactly as though the mechanical reels were revolving, and the symbols were changing. In this case, although, in the regular game condition, the symbol arrangement pattern A of FIG. 6 is selected, in the event that a prescribed condition (in the embodiment, the condition is that the game quantity reaches one thousand), the symbol arrangement pattern B shown in FIG. 7 is selected. The symbol arrangement pattern B being configured with “JACKPOT 7” symbols, which configure symbols of a big bonus, and symbols which configure no winning combination at all, so-called “blank” symbols, the reel A to the reel I, the symbols of which are allotted a code number from 0 to 21, are cyclically scroll displayed, in the same way as with the symbol arrangement pattern A.

Also, the symbol arrangement pattern B having a larger number of the “JACKPOT 7” symbols in comparison with the symbol arrangement pattern A, a selection probability of the big bonus, which is a privilege relatively advantageous to the player, increases. That is, as a transfer is made, by the fulfillment of the heretofore described prescribed condition, to a game condition according to the symbol arrangement pattern B, in which the selection probability of the big bonus has increased, as well as a player's sense of expectation and excitement being increased, as a game result is only either the big bonus or a loss, a game condition (the game result) is clarified for the player. Regarding a reset of this kind of condition, in the embodiment, it is reset at a point at which the big bonus is acquired, or a prescribed quantity of games based on the game quantity counter value has been played.

Then, in the event that either of the heretofore described symbol arrangement patterns has been selected, the symbols stop displayed in the variable display portions 22A to 22C, 23A to 23C and 24A to 24C are, for example, as described hereafter, determined by the CPU 32, which is the controller.

The heretofore described main CPU 32, on detecting the start operation of the player (for example, the operation of the spin switch 8), in response to the detection (that is, taking the game start as an impetus), instructs the random number generator 35 to generate the random numbers in the certain range. Also, the main CPU 32 instructs the sampling circuit 36 to extract the optional random number from among the random numbers generated by the random number generator 35. The main CPU 32, on the random number being extracted, sets the random number in a search key and, with reference to the symbol selection table stored in the ROM 34, determines the symbols to be stopped. In this case, in the event that the symbol arrangement pattern A shown in FIG. 6 is set, a symbol selection table A shown in FIG. 8A is selected, while in the event that the heretofore described prescribed condition is fulfilled and the symbol arrangement pattern B shown in FIG. 7 is set, a symbol selection table B shown in FIG. 8B is selected, and the stopped symbols of each reel are determined.

In accordance with the extracted random number value, code numbers correlated to the symbols determined in accordance with the symbol selection tables shown in FIGS. 8A and 8B being affixed to them in advance, the code number of the relevant symbol is acquired. Next, the main CPU 32 sets the acquired code number in the search key and, referring to the symbol arrangement pattern table ordered by reel (refer to FIG. 6 and FIG. 7), searches for a stopped symbol to be stop displayed in the variable display portion. For example, regarding the reel A in the variable display portion 22A, in the event that an “ORANGE” symbol is determined by the random number value (any value from 0 to 63) extracted in the symbol selection table A shown in FIG. 8A, one of the code numbers 2, 4, 6, 10, 12, 15 or 18 correlated thereto and affixed in advance is determined (although a determination method is not particularly limited, for example, a code number of a position nearest to the stopped symbol in a previous game is acquired).

The heretofore described kind of random number extraction, symbol selection table search and symbol arrangement table search are carried out a total of nine times, once for each of the variable display portions 22A to 22C, 23A to 23C and 24A to 24C. That is, by carrying out the table searches a quantity of times corresponding to a quantity of the variable display portions, the stopped symbols in the variable display portions 22A to 22C, 23A to 23C and 24A to 24C are determined.

On the stopped symbol being determined for each of the variable display portions by means of the heretofore described kind of procedure, stopped symbol information, as shown in FIG. 9, is stored, for each activated pay line, with address information attached, in an activated pay line symbol storage area of the RAM 33. In this case, in order to simplify a description, FIG. 9 shows a storage example of a case in which a stop control position of each reel positioned in the variable display portions is the code number 20 shown in FIG. 6.

Then, the main CPU 32, based on the determined stopped symbol of each reel and referring to a winning combination determination table shown in FIG. 10, specifies the winning combination. Herein, as shown in FIG. 9, as “BELL”'s are aligned on line L4, the “BELL”'s are specified as the winning combination, the medal payout quantity is determined (in the event that the BET quantity is one, the payout quantity is eight), and a payout process is executed.

In the embodiment, as a combination of “APPLE” symbols is a trigger for a transfer to the free game, by “APPLE” being established as the winning combination, a relatively large profit is granted to the player. The free game being, for example, of a special game aspect in which the heretofore described game can be played a prescribed quantity of times without inserting the medal, the player, during this time, can receive a payment of the medal without reducing the quantity of medals or credits, and has a great advantage as regards a medal acquisition. Regarding the quantity of free games which can be executed, when “APPLE” is established as the winning combination, the selection process is executed, and the main CPU 32 determines the quantity of games based on a free game quantity selection table shown in FIG. 11.

Then, when the winning combination is determined in the heretofore described way, an effect corresponding to the winning combination is carried out. The effect being determined, in accordance with an effect table shown in FIG. 12, by the selection process, an effect image stored in advance correlated to an effect identifier determined by the selection is selected, and the selected effect image is displayed for a prescribed time on the main display 3 or the sub-display 4. Also, in addition to the effect by the image, it is also acceptable to carry out an effect related to the sound by means of the speakers 12L and 12R.

Next, a description will be given, while referring to flowcharts, of a control method which controls the implementation of the game in the heretofore described slot machine 1 according to the embodiment. In the flowcharts shown hereafter, a step will be abbreviated to S. Also, the following processes are carried out by the main CPU 32, which is the controller, executing information related to a slot game of the programs stored in the ROM 34 and the RAM 33.

FIG. 13 is a flowchart showing an example of the main process in the heretofore described slot machine 1.

By a start of the main process, the slot machine 1 (more specifically, the main CPU 32) executes a one game finishing time initialization process (S1). This process is a process which, for example, being a process in which the main CPU 32 initializes prescribed data (the data stored in the RAM 33, communication data etc.) in an initialization condition in which a power switch of the slot machine 1 has been put in an on condition, carries out, in a condition in which the game is being played, a deletion process of parameters stored in the RAM 33 at a previous game finishing time, a writing process of parameters to be used in a next game, a specification of a start address of a sequence program, and the like.

Next, the main CPU 32 carries out the medal insertion process (S2). A description of the medal insertion process will be given with reference to a flowchart shown in FIG. 14.

First, it is judged whether or not the insertion of the medal has been detected by the inserted medal sensor installed in the medal insertion slot 6 (S21). If the insertion of the medal has been detected, an update of a credit quantity counter is carried out (S22), and an acceptance of a BET button operation is permitted (S23). Then, if the BET button operation is detected in a condition in which the acceptance of the BET button operation has been permitted, 8 is set in an activated payout line counter (S24; Yes, S25; Yes, S26). The activated pay lines here corresponding to the activated pay lines L1 to L8 shown in FIG. 3, all the lines L1 to L8 are activated by the BET operation.

Even if the medal is not inserted in S21, if a prescribed quantity of medals is in an accredited condition, the BET button operation is accepted regardless (S21; No, S24 to S26).

Continuing, an update process of a BET quantity counter and the credit quantity counter is carried out based on the BET button operated (S27). In the event that, by this operation, the BET quantity counter has reached a maximum value, the update of the BET quantity counter is forbidden (S28; Yes, S29), and a permitting of a spin button operation acceptance is carried out (S30). Also, in S28, if the BET quantity counter has not reached the maximum, the permitting of the spin button operation acceptance is carried out immediately (S28; No, S30).

Then, the player operates the spin button 8 and, when the operation is detected by the spin switch 8a (S31), the medal insertion process finishes, and the main CPU 32 moves to the selection process of the main flowchart shown in FIG. 13 (S4). If the player does not operate the spin button 8 in S31, the process of S21 to S31 is repeated.

Continuing on from the medal insertion process of S2, the main CPU 32 moves to the selection process (S3) A description will be given of the selection process, with reference to the flowchart shown in FIG. 15.

The selection process being carried out as a result of the signal from the spin switch 8a being received, the main CPU 32 extracts the random number value via the random number sampling circuit 36 (S41). Continuing, it is determined whether or not the prescribed condition has been established, that is, in the embodiment, whether or not the game quantity counter is at 1,000 or more (S42). If the game quantity counter is at less than 1,000 (S42, No), the symbol arrangement pattern A shown in FIG. 6 is set, and the symbol to be stopped in each reel is determined based on the symbol selection table A shown in FIG. 8A (S44). Meanwhile, in S42, if the game quantity counter is at 1,000 or more, the symbol arrangement pattern B shown in FIG. 7 is set, and the symbol to be stopped in each reel is determined based on the symbol selection table B shown in FIG. 8B (S43).

At this time, the determination of the symbol to be stopped being carried out a total of nine times, once for each of the variable display portions 22A to 22C, 23A to 23C and 24A to 24C, the symbol to be stopped is determined for all of the variable display portions 22A to 22C, 23A to 23C and 24A to 24C.

Continuing on from the selection process of S3, the main CPU 32 moves to the winning search process (S4). A description will be given of the winning search process, with reference to the flowchart shown in FIG. 16.

First, the symbols to be stopped, determined in S43 or S44 in the heretofore described selection process, are stored in the activated pay line symbol storage area of the RAM 33, as shown in FIG. 9 (S51). At this time, a numeric value 8 is set in an activated pay line counter of the RAM 33.

Next, the main CPU 32 acquires an initial address (address 101) stored, in S51, in the activated pay line symbol storage area shown in FIG. 9, and specifies the winning combination and the payout quantity based on a combination of symbols of each activated pay line specified by the address, and on the winning combination determination table shown in FIG. 10 (S52, S54). This kind of process specifying the winning combination and the payout quantity is executed for all addresses (all the activated pay lines L1 to L8). That is, after the process of S54, the main CPU 23 reduces a value of the activated pay line counter set in S51 by one (S55), acquires a next address stored in the activated pay line storage symbol area (address 102), and repeats this until the activated pay line counter is at zero (S53 to S56). Then, at a point at which the activated pay line counter reaches zero, it updates a value of a payout quantity counter of the RAM 33 based on the specified payout quantity, and finishes the winning search process (S57).

In the aspect shown in FIG. 9, as the “BELL” symbols come together in the activated pay line L4 when executing the address 104, the winning combination of the “BELL” being established, a payout quantity of 8 is determined from the winning combination determination table of FIG. 10, and finally the numeric value 8 is set in the payout quantity counter of the RAM 33.

Continuing on from the winning search process of S4, the main CPU 32 moves to the reel drive control process (S5). A description will be given of the reel drive control process, with reference to the flowchart shown in FIG. 17.

First, the main CPU 32 specifies an effect identifier based on the winning combination specified by S54 and on the effect table shown in FIG. 12, and stores it in the RAM 33 (S71). In this case, if the effect identifier has not been set (if the effect is not carried out), the main CPU 32 sets two seconds in a reel revolution stop timer and, based on the set symbol arrangement pattern (the symbol arrangement pattern A or the symbol arrangement pattern B), executes a reel revolution process (S72; Yes, S73 and S75). Then, after the two seconds have elapsed, a reel revolution stop process is executed, causing the symbols determined by the selection to stop in such a way as to be displayed in the reels (S77 and S78).

Meanwhile, if there is an effect identifier, the main CPU 32 sets an effect time specified in the effect table shown in FIG. 12 in the reel revolution stop timer and, based on the set symbol arrangement pattern, executes the reel revolution process (S72; No, S74 and S75). In this case, the effect image correlated to the effect identifier and stored in advance is selected, the selected effect image is displayed for a corresponding time on the main display 3 or the sub-display 4, and the reel revolution stop process is executed (S76 to S78).

In the heretofore described reel drive control process, as a probability of the effect fixed in advance corresponding to the winning combination, as in the effect table shown in FIG. 12, being carried out is high, as well as the player, depending on the effect carried out when the reel is revolution driven, being able to predict a certain level of the winning combination, as a case of not winning even though that kind of effect is carried out (a so-called bogus effect), or a case of winning even though the effect is not carried out, can occur, a heightening of interest is achieved.

Continuing on from the reel drive control process of S5, it is determined whether or not a free game trigger is established (S6) and, if the free game is not established (S6, No), a game quantity counting process is executed (S8), after which a medal payout process is executed based on the value of the payout quantity (the value of the payout quantity counter) specified by S54 in the winning search process (S9).

The game quantity counting process in S8 is executed, for example, in accordance with a procedure of the flowchart shown in FIG. 18.

First, it is determined whether or not, in a game currently being executed, the “JACKPOT 7”'s, which are the stopped symbols of the big bonus, have been obtained and, if the “JACKPOT 7”'s have been obtained (S81; Yes), the main CPU 32 clears the game quantity counter, and finishes the process (S83). In this case, in an initial condition in which a power switch has been put in an on condition, the game quantity counter is set in a clear condition.

In S81, if the “JACKPOT 7”'s have not been obtained, continuing on, it is determined whether or not the game quantity counter has reached 1,050 and, at a point at which the game quantity counter reaches 1,050 (S82; Yes), the main CPU 32 clears the game quantity counter, and finishes the process (S83). Also, if the game quantity counter has not reached 1,050 (S82; No), the main CPU 32 immediately adds one to the game quantity counter, and finishes the process (S84).

To specifically describe the aforementioned processes in terms of a game procedure, in the selection process carried out while playing successive games (refer to FIG. 15), as the symbol arrangement pattern B shown in FIG. 7 is set when the game quantity counter reaches 1,000 or more, which is the prescribed condition, it becomes easier, in comparison with games played thus far (from a first game to a nine hundred and ninety-ninth game), to obtain the “JACKPOT 7”'s, which are the big bonus. The setting of the symbol arrangement pattern B, that is, a quantity of games in which it is easier to obtain the big bonus, is executed for a maximum of fifty games and, as the game quantity counter is cleared in the event that the “JACKPOT 7”'s are obtained during that time, the symbol arrangement pattern A is set once more.

That is, in the event that the “JACKPOT 7”'s, which are the big bonus, are not obtained during the prescribed quantity of games (1,000 games), the symbol arrangement pattern B, with which it is comparatively easy to obtain that kind of big bonus, is set, granting a privilege to the player for a maximum of fifty games.

Also, in the process of S6, if the free game trigger is established, the free game process is executed. The free game, as described heretofore, being established when the “APPLE” symbols come together as the winning combination on any one of the activated pay lines, this kind of free game is a right whereby the player can play the game the prescribed quantity of times, without inserting the medal. Hereafter, a procedure of the free game process will be described in accordance with the flowchart shown in FIG. 19.

When executing the free game process, the main CPU 32 turns on a free game flag and, by means of the selection process, determines the quantity of free games based on the free game quantity selection table (refer to FIG. 11) (S91 and S92). A numeric value of the quantity of free games determined by the selection process is set in the free game quantity counter of the RAM 33 (S93).

Continuing on, the selection process, the winning search process and the reel drive control process are executed in accordance with a game operation of the player (S94 to S96). These processes are carried out in accordance with the heretofore described flowcharts shown in FIG. 15, FIG. 16 and FIG. 17 respectively.

Then, after the heretofore described reel drive control process of S96 (S71 to S78) is finished, it is judged whether or not the free game trigger is established (S97). That is, if, during the free game presently being executed, the winning combination is again established by the “APPLE” symbols being aligned on any one of the activated pay lines, during the heretofore described process procedures of S94 to S96 (S97; Yes), the free game trigger is established, the quantity of free games is determined, by means of the selection process, based on the free game quantity selection table (refer to FIG. 11) (S98), and the quantity of free games determined is added to the free game quantity counter (S99). That is, it means that, even during a playing of the free game, in a case in which the free game is established, a right thereof is added, and it is possible by this means for the player to obtain a greater profit.

Even during the free game, in the event that the “JACKPOT 7”'s which are the big bonus, are obtained, the value of the game quantity counter accumulated thus far is cleared (S100; Yes, S101).

Then, the quantity of medals obtained during the heretofore described game process procedure of S94 to S96 being stored in the payout quantity counter, and updated (S102), the main CPU 32 reduces a value of a free game quantity counter by one (S103). The heretofore described free game is executed until the free game quantity counter reaches zero (the quantity of times obtained by the selection process) (S104; No, S94 to S104) and, at a point at which the free game quantity counter reaches zero, the free game flag is turned off (S104; Yes, S105).

Subsequently, the main CPU 32 carries out the payout process of the medals (the value of the payout quantity counter) obtained by the heretofore described procedure (S106), and the free game is finished. That is, the medals obtained during the free game are paid out at one time at a point at which the free game is finished.

According to the slot machine including the heretofore described kind of game procedure, on the prescribed condition being established (on the game quantity reaching 1,000), as the symbol arrangement pattern B, in which it is easy to obtain the “JACKPOT 7”'s, which are the big bonus symbols, is set, differing from the symbol arrangement pattern A visually perceived thus far, a highly intriguing, diverse gaming aspect can be produced. That is, as a gaming machine to date has implemented the game based on one symbol arrangement pattern, on the whole there have been few instances of winning the big bonus but, as described heretofore, as a separate symbol arrangement pattern is selected and the big bonus becomes comparatively easier to win by the prescribed condition being fulfilled, it is possible to increase the player's sense of expectation. Also, as there is also an instance of the player continuing the game with an aim of the prescribed condition being fulfilled, it is also possible to increase an operating rate of the gaming machine.

Also, in the embodiment, the symbol arrangement pattern B, in which it is easy to obtain the “JACKPOT 7”'s, which are the big bonus symbols, is set by the prescribed condition being established. Although a probability of obtaining the big bonus increases, conversely, as symbols other than the big bonus symbols are blank symbols, and winning combinations other than the big bonus are eliminated, regarding a payout rate, it is possible to set in such a way that there is no change from the regular game. Also, as there are only two game patterns, the big bonus and the loss, a time of waiting for the medal payout such as when winning a small bonus, and a related annoyance, are eliminated.

Although the description has heretofore been given of the embodiment of the invention, the invention, not being limited to the heretofore described embodiment, can be implemented in a variety of aspects, for example, as described hereafter.

Although, in the embodiment, the prescribed condition which changes the symbol arrangement pattern is the quantity of games, it is possible to appropriately modify the prescribed condition to, for example, an elapsing of a prescribed time, an obtaining of a specified winning combination, the specified winning combination being obtained a prescribed quantity of times, a quantity difference (a difference between an insertion quantity and the payout quantity) reaching a prescribed value, or the like.

Also, although the changing symbol arrangement pattern B has only two kinds of symbol (the JACKPOT 7 symbol and the blank symbol), it is possible to appropriately modify the kinds and quantity of the symbols.

Also, in the embodiment, the game quantity when the symbol arrangement pattern 3 is selected is limited (fifty games), but it is also acceptable, without setting this kind of limit, to play until the “JACKPOT 7”'s, which are the big bonus, are obtained. Also, when the symbol arrangement pattern B is selected, it is also acceptable to set a game finishing condition as a time, a quantity of wins, a winning combination, or the like.

Also although, in the embodiment, the “JACKPOT 7” symbols, which are the specified symbols, are increased by the prescribed condition being established, conversely it is also acceptable to decrease them (in this case, the probability of obtaining the big bonus also decreases).

Also although, in the embodiment, two patterns are used as the symbol arrangement patterns, it is also acceptable to use three or more symbol arrangement patterns, or to adopt a configuration in which the symbol arrangement pattern is changed by having one symbol arrangement pattern, and only changing specified symbols within it.

Furthermore, in the heretofore described embodiment, the slot machine having nine variable display portions has been exemplified as the gaming machine, but it is also acceptable that it is a so-called three reel slot machine or five reel slot machine, having three or five variable display portions, while it is also acceptable that a variable display device is configured of mechanical reels. Also, the invention can be applied to a gaming machine other than the slot machine, such as, for example, a card game machine or a pachinko machine.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming apparatus comprising:
a display which, including a plurality of variable display portions each displaying one symbol, displays a plurality of symbols;
a memory which stores a first symbol arrangement pattern which fixes symbol arrangements to be displayed in the variable display portions, and a second symbol arrangement pattern which becomes a game condition differing from a game condition according to the first symbol arrangement pattern; and
a controller which controls the display and the memory, wherein
the controller,
(a) based on a prescribed condition, selects either the first symbol arrangement pattern or the second symbol arrangement pattern, and carries out a varying display of the symbols on the display,
(b) determines symbols to be displayed in the variable display portions based on the selected symbol arrangement pattern, and
(c) in the event that a combination of the determined symbols is one of a pre-determined plurality of winning combinations, carries out an award.

2. The gaming apparatus according to claim 1, wherein kinds of symbol included in the second symbol arrangement pattern are fewer than kinds of symbol included in the first symbol arrangement pattern.

3. The gaming apparatus according to claim 2, wherein
the first symbol arrangement pattern and the second symbol arrangement pattern include specified symbols configuring a winning combination which grants a privilege relatively advantageous to the player, wherein,
by making a quantity of the specified symbols included in the second symbol arrangement pattern greater than that of the specified symbols included in the first symbol arrangement pattern, an acquisition probability of the relevant specified symbols is increased.

4. The gaming apparatus according to claim 3, wherein the second symbol arrangement pattern is configured with the specified symbols and blank symbols which configure no plurality of winning combinations at all.

5. The gaming apparatus according to claim 1, wherein
the prescribed condition is a number of times the game is played.
